(19) United States
(12) Patent Application Publication
(10) Pub. No.: US 2015/0379202 A1
(43) Pub. Date: Dec. 31, 2015

(54) SYSTEM AND METHOD FOR SECURELY MANAGING MEDICAL INTERACTIONS

(71) Applicant: POCTOR INC., Smithfield, RI (US)

(72) Inventors: Michael Scott Plasse, Lincoln, RI (US); Thomas Anthony Capozza, Barrington, RI (US); Todd Mitchell Cooper, Franklin, MA (US); Christopher Miles Geagon, SR., Swansea, MA (US)

(21) Appl. No.: 14/316,980

(22) Filed: Jun. 27, 2014

(51) Int. Cl. G06F 19/00; H04W 12/02; H04L 29/06

(52) U.S. Cl. CPC G06F 19/322; H04L 63/08; H04L 63/101; H04L 63/0428; H04W 12/02

(57) ABSTRACT

Disclosed are peer-to-peer mobile applications that manage secure and intelligent communication between medical providers, patients, and/or physicians. The mobile application can be configured to provide an encrypted mixed media messaging system between registered users that provide, for example, a HIPAA compliant messaging platform. A secure messaging system can controls delivery of the mobile application and provide functionality to enable providers to control the messaging environment. The secure messaging system can be architected to provide geographically located servers. The geographically located servers can be configured to manage secure communication and implement geographically based communication requirements. In various embodiments, a plurality of communication management servers can be located in multiple jurisdictions, each managing respective communication requirements and/or restrictions.

### BACKGROUND

Various conventional approaches attempt to connect patients with medical information that is relevant to them and their issues. The well known Web MD is one such site that provides medical information to user responsive to their searches for medical information. These static sources of medical information fail to leverage modern communication channels and fail to facilitate direct provider to patient interaction and/or provider to provider interaction.

Complicating the development and adoption of such technology are strict health related management laws and statutes. Notably the Health Insurance Portability and Accountability Act (“HIPAA”) set out rigorous rules and obligations on the exchange of protected health information. Thus, integrating medical information systems into physician practice and patient daily lives has proven challenging and ultimately has had limited penetration with actual patients and physician providers.

### SUMMARY

It is realized that new system, applications, and communication tools are needed to bridge the communication gaps in and between medical providers, patients, and physicians. According to some embodiments, peer-to-peer medical platforms are provided that form a backbone for mobile applications and/or desktop applications to communicate medical information.

According to some aspects and embodiments, provided is a peer-to-peer mobile application that manages secure and intelligent communication between medical providers, patients, and/or physicians. The mobile application can be configured to provide an encrypted mixed media messaging system between registered users (e.g., physicians, patients, and/or providers) that provides a HIPAA compliant messaging platform. According to some embodiments, a secure messaging system controls delivery of the mobile application and provides functionality to enable providers to control the messaging environment. According to one embodiment, an initial provider administrator user (i.e., a provider user having an administrator role) is required to register any other provider users. The providers can then add patients into the secure messaging system. Once the patients are authenticated, secure messaging can take place between the providers and patients, and between the provider and provider. Access to messaging functions can be controlled by the provider admin and other registered providers (e.g., physicians). According to one aspect, providing the physician with control over participants ensures messaging compliance and prevents unwanted communication. In some embodiments, patient participation is restricted until a provider (e.g., a physician) enables patient access. In some examples, the physician can provide registration access without the ability to communicate. In one example, communication functions by patients are locked out by default. The provider and/or admin must release the blocks preventing messaging activity in order for patients to message their providers and/or physicians.

Further embodiments enable secure referral to another provider account. In some examples, provider referrals are configured to automatically add the referred patient to the provider's account. According to one example, once added to the provider's account, the referred patient can communicate with the referred provider.

According to one embodiment, the secure messaging system is architected to provide geographically located servers. The geographically located servers can be configured to manage secure communication and implement geographically based communication requirements. According to one aspect, many difficulties arise with medical communication compliance, not only based on federal regulation but also because individual states or other jurisdictions may implement additional restrictions, more strenuous restrictions, and/or different regulations that govern communication, content, format, and/or management of medical information. In various embodiments, a plurality of communication management servers can be located in multiple jurisdictions, each managing respective communication requirements and/or restrictions. The plurality of communication management servers can be configured to implement secure messaging channels between medical providers, patients, and/or physicians where respective communication management servers can analyze messages in transit, ensure compliance, and/or modify non-compliant messaging based on, for example, an originating communication location and an delivery communication location. In some embodiments, the secure messaging system is configured to mediate communicate between a first user device, a first communication server having a first communication requirement, a second communication server having a second communication requirement, and a second user device. peer-to-peer mobile application that manages secure and intelligent communication between medical providers, patients, and/or physicians.

According to one aspect, a system for securely managing communication of medical information is provided. The system comprises at least one processor operatively connected to a memory, the at least one processor configured to instantiate and run a plurality of system components when executing, wherein the plurality of system component comprising an authentication component configured to identify a plurality of users and respective user roles for the plurality of users; a communication component configured to restrict communication functions between the plurality of users based on respective user role and message content; and a regulatory component configured to evaluate communication content based at least in part on a sending user's location or a receiving user's location. In one embodiment, the communication component is further configured to generate a notification message to a recipient from content of an original message for the recipient responsive to communicate of the original message. In one embodiment, the communication component is further configured to generate the notification message by extracting non-regulated message content. (e.g., message classification information (e.g., high priority, emergency, normal priority, low priority).

In one embodiment, the communication component is further configured to generate a notification message configured for delivery without encryption. In one embodiment, the regulatory component is configured to execute regulatory rules on communicated content based, at least in part, on evaluating a set of regulatory requirements associated with a sender's location. In one embodiment, the regulatory component is configured to execute regulatory rules on communicated content based, at least in part, on evaluating a set of regulatory requirements associated with a recipient's location. In one embodiment, the regulatory component is configured to execute regulatory rules on communicated content based, at least in part, on evaluating first set of regulatory requirements associated with a sender's location and a second set of regulatory requirements associated with a recipient's location. In one embodiment, the regulatory component is further configured to modify message content as part of executing the regulatory rules on the communicated content. In one embodiment, the regulatory component is further configured to modify the message content by extracting medical information and inserting links into the message for the extracted medical information.

In one embodiment, the system further comprising a back up component configured to archive communication content delivered by the system. In one embodiment, the back up component is further configured to archive the communication content responsive to execution of regulatory rules defining storage requirements. In one embodiment, the regulatory component is further configured to execute regulatory rules defining data retention requirements based at least in part on one or more members of a group comprising a patient location associated with the data, a recipient location associated with the data, a location of a storage device associated with the archive.

According to one aspect, a computer implemented method for securely managing communication of medical information is provided. The method comprises identifying, by a computer system, a plurality of users and respective user roles for the plurality of users; restricting, by the computer system, communication functions between the plurality of users based on respective user role and message content; and evaluating, by the computer system, communication content based at least in part on a sending user's location or a receiving user's location and medical information in the communication content. In one embodiment, the method further comprises an act of generating, by the computer system, a notification message to a recipient from content of an original message for the recipient responsive to communicate of the original message. In one embodiment, the act of generating the notification message, includes generating the notification message by extracting non-regulated message content (e.g., message classification information (e.g., high priority, emergency, normal priority, and low priority among other options)).

In one embodiment, generating the notification message includes generating a notification message configured for delivery without encryption. In one embodiment, the act of evaluating includes executing, by the computer system, regulatory rules on communicated content based, at least in part, on evaluating a set of regulatory requirements associated with a sender's location. In one embodiment, the act of evaluating includes executing, by the computer system, regulatory rules on communicated content based, at least in part, on evaluating a set of regulatory requirements associated with a recipient's location. In one embodiment, the act of evaluating includes executing, by the computer system, regulatory rules on communicated content based, at least in part, on evaluating first set of regulatory requirements associated with a sender's location and a second set of regulatory requirements associated with a recipient's location.

In one embodiment, executing the regulatory rules includes modifying message content as part of executing the regulatory rules on the communicated content. In one embodiment, executing the regulatory rules includes modifying the message content by extracting medical information and inserting links into the message for the extracted medical information. In one embodiment, the method further comprises an act of archiving, by the computer system, communication content delivered by the system. In one embodiment, the act of archiving includes archiving the communication content responsive to execution of regulatory rules defining storage requirements. In one embodiment, the act of archiving includes executing regulatory rules defining data retention requirements based at least in part on one or more members of a group comprising a patient location associated with the data, a recipient location associated with the data, a location of a storage device associated with the archive.

According to one aspect, a system for securely managing medical interactions is provided. The system comprises at least one processor operatively connected to a memory, the at least one processor configured to instantiate and run a plurality of system components when executing, wherein the plurality of system component comprise; an authentication component configured to identify a plurality of users and respective user roles for the plurality of users; a communication component configured to restrict communication functions between the plurality of users based on respective user role; a role component configured to define user roles for the plurality of users including at least a patient role and a provider role, wherein users having the patient user role are prevented from accessing the system until invited, and prevented from communicating with the users of the system until explicitly authorized by a user having the provider role. In one embodiment, the role component is configured to define at least the patient role, the provider role, and a physician role that includes at least the functions of the provider role. In one embodiment, the role component is configured to define the provider role to include a physician role.

In one embodiment, the system further comprises an application generation component configured to tailor a mobile application (e.g., iPhone application, android application, etc.) to one or more provider users. In one embodiment, the application generation component publishes the mobile application to a third party store. In one embodiment, the application generation component publishes the mobile application for access through a secure website. In one embodiment, the system comprises a registration component configured to require entry of verification information for a user wishing to access the mobile application. In one embodiment, the system further comprises a verification component configured to verify provider information (e.g., physicians) submitted to the registration component. In one embodiment, the registration component requires submission of any one or more of: social security number, national provider identifier number, and work address plus phone number.

In one embodiment, the registration component is configured to capture a device token or device identifier for each registered user. In one embodiment, the system further comprises an encryption component configured to encrypt any communication between the users. In one embodiment, the encryption component generates encrypted data based, at least in part, on the captured device token or the device identifier. In one embodiment, the mobile application is configured to capture at least one media source from a user device on which the mobile application is installed and accept the at least one media source into a secure messaging channel provided by the mobile application.

In one embodiment, the communication component is configured to execute a secure referral function, when executed enables users having the physician role to securely refer a patient and medical information to another physician. In one embodiment, the communication component is configured to automatically add a patient to the physician receiving the referral verified communication lists. In one embodiment, the system further comprises an analysis component configured to analyze communicated content to ensure compliance with regulatory rules based at least in part on a sender's location and a receiver's locations.

According to one aspect, a computer implemented method for securely managing medical interactions is provided. The method comprise identifying, by a computer system, a plurality of users and respective user roles for the plurality of users; restricting, by the computer system, communication functions between the plurality of users based on respective user role; defining, by the computer system, user roles for the plurality of users including at least a patient role and a provider role; and preventing, by the computer system, users having the patient user role from accessing the system until invited and from communicating with the other users of the system until explicitly authorized by a user having the provider role.

In one embodiment, the method further comprises defining at least the patient role, the provider role, and a physician role that includes at least the functions of the provider role. In one embodiment, defining the provider role further comprises act of defining the provider role to include a physician role. In one embodiment, the method further comprises customizing a mobile application (e.g., iPhone application, android application, etc.) to one or more provider users. In one embodiment, the method further comprises publishing the mobile application to a third party store. In one embodiment, the method further comprises publishing the mobile application for access through a secure website.

In one embodiment, the method further comprises requiring entry of verification information for a user wishing to access the mobile application. In one embodiment, the method further comprises verifying provider information (e.g., physicians) submitted to the registration component. In one embodiment, the method further comprises requiring submission of any one or more of: social security number, national provider identifier number, and work address plus phone number. In one embodiment, the method further comprises capturing a device token or device identifier for each registered user. In one embodiment, the method further comprises encrypting any communication between the users. In one embodiment, the method further comprises generating encrypted data based, at least in part, on the captured device token or the device identifier. In one embodiment, the method further comprises capturing at least one media source from a user device on which the mobile application is installed and accepting the at least one media source into a secure messaging channel provided by the mobile application.

In one embodiment, the method further comprises executing a secure referral function, when executed enables users having the physician role to securely refer a patient and medical information to another physician. In one embodiment, the method further comprises adding, automatically, a patient to the physician receiving the referral verified communication list. In one embodiment, the method further comprises analyzing communicated content to ensure compliance with regulatory rules based at least in part on a sender's location and a receiver's locations.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a block diagram of an example secure messaging system, according to one embodiment;

FIG. 2 is a block diagram of an example secure messaging environment, according to one embodiment;

FIG. 3A is an example process flow for communicating secure messages between users, according to one embodiment;

FIG. 3B is an example process flow for communicating secure messages between users, according to one embodiment;

FIG. 4 is an example process flow for registering users for the secure system, according to one embodiment;

FIG. 5 is a block diagram of a general purpose computer system, specially configured to execute various aspects and embodiments; and

FIG. 6 is a screen capture of an example user interface for messaging, according to one embodiment;

FIGS. 7-15 are embodiments of example user interface elements for secure messaging functions; and

FIGS. 16-21 are example site map flows for embodiments of a secure messaging service.

### DETAILED DESCRIPTION

Stated broadly, various aspects and embodiments are directed to secure medical messaging systems and methods. According to some embodiments, doctors, medical practitioners, medical providers, etc., can download a secure messaging application. For example, users can access an application store for downloading and/or purchasing the secure messaging application. Once installed (e.g., on a mobile computing device, laptop, desktop, etc.) the user can securely access medical messages including medical content that must meet any HIPAA regulations. Messaging between the downloaded applications can be managed by one or management servers. In some embodiments, the one or more management servers mediate all communication between the end users. For example, the one or more management servers can be configured to evaluate messages in transit and ensure regulatory compliance.

According to one embodiment, the secure messaging system is architected to provide geographically located servers. The geographically located servers can be configured to manage secure communication and implement geographically based communication requirements. According to one aspect, complying with federal requirement for electronic communication of medical information requires meeting the federal requirements for such communication, however, when such messages cross local jurisdiction boundaries additional restrictions may be required. According to further embodiments, the geographically located servers manage local communication requirements and can be configured to modify in transit messages to ensure compliance with a plurality of local communication requirements. In other embodiments, data storage requirements may be also change based on an accessing user's location. Thus, the system can be configured to manage where medical data is being stored responsive to the accessing user's location.

According to another embodiment, the system can be configured to manage users who are allowed to access and/or user the system and any associated applications. In one embodiment, participation is managed such that participation is by invitation only. For example, users can register with a system hosted domain (e.g., Poctor.com), provider/licensure information can be verified by the system (e.g., the system can require and verify social security number (“SSN”) or e.g., last four of SSN), national provider identifier (NPI) number, and work address/phone#). According to some embodiments, the system can be configured to require the use of a specific device to access the system to register and/or verify their identity. Verification can include identifying a user associated device.

Once verified the system can be configured to communicate a user ID and password, for example, via email or a push notification. In one example, the system can be configured to provide different functions based on user role. For example, administrative providers can configure the system for use by a group of administered users. In another example, individual users can configure their own account.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

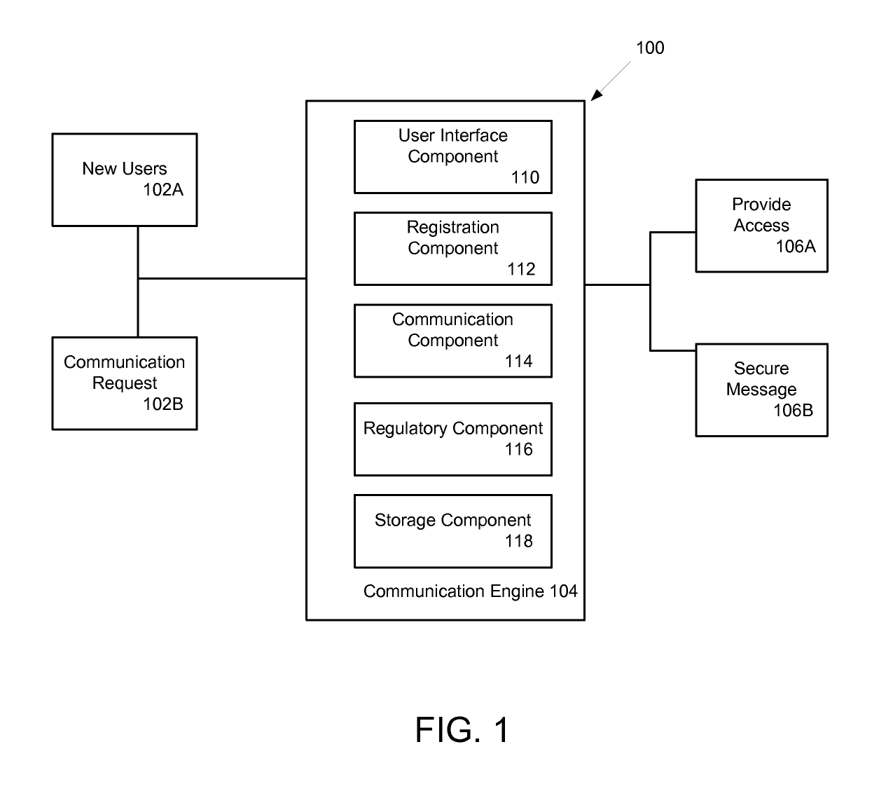

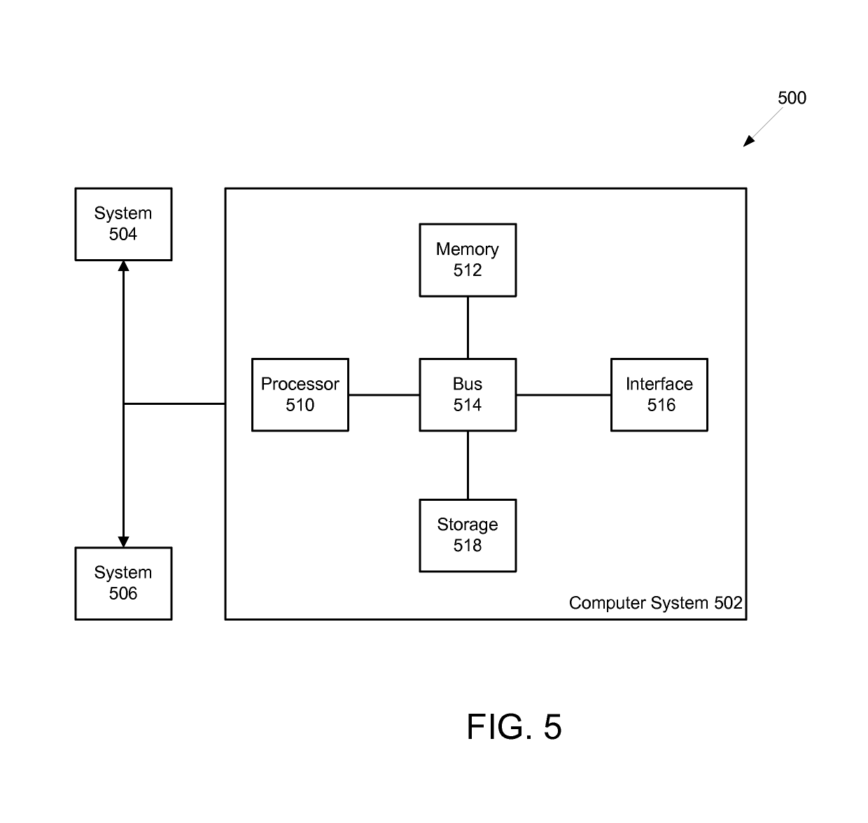

FIG. 1 is a block diagram of an example system 100 for securely messaging medical information. According to one embodiment, the system 100 can include a communication engine 104 for execution of the functions and/or operations discussed herein, for example, with respect to system 100. In other embodiments, the system 100 and/or engine 104 can include or instantiate other system components for performing specific functions or operations. For example, the system 100 and/or engine 104 can be executed on a specially configured general purpose computer system (e.g., system 500 or 502 discussed below with respect to FIG. 5). In further examples, the system 100 and/or engine 104 can executed the system components on the specially configured general purpose computer system (e.g., system 500 or 502 discussed below with respect to FIG. 5).

According to some embodiments, system 100 is configured to enable medical providers, physicians, etc., to download a secure messaging application from an application store (e.g., ITUNES App Store or Google Play). In other examples, users can download the application via an email invitation or through access to a system hosted web-site (e.g., Poctor.com). New users (e.g., 102A) can access system 100, register, and receive access information (e.g., 106A) for using the secure messaging application. In some embodiments, the system is configured to recognize user devices and associate specific devices with users as part of registration.

According to one embodiment, the application can be tailored to the device on which the user will install it. For example, the application can include functionality associated with a mobile device and a desktop (https) version. Users can download either or both as desired. According to some embodiments, new users (e.g., 102A) register on a system hosted website (e.g., Poctor.com). The registration information for the user can be verified by the system. In one embodiment, the system is configured to verify social security information, NPI number, and/or work address/phone# before a user is granted verified status. Once users are verified, the system communicates a user ID and password (e.g., 106A).

According to one embodiment, user environment information (e.g., information on the user's device, computer, software, hardware, including, for example, a device token) can be collected during registration. Capture of environment information can include analysis of the user device used to register, and information specific to the device can be captured and associated with the user. For example, hardware information for the device can be captured, including hardware specifications, identifiers, etc. Information on the software installed on the device can also be captured. According to some embodiments, the system is configured to employ environment information as part of encryption operations (e.g., stored medical data is encrypted) for respective users. In some examples, captured environment information can be used to generate encryption keys for communication between users.

In further embodiments, environment information can be used to filter content presentation by the system (e.g., system hosted web-pages, accessed via the secure application, etc). In one example, the system can select content for display based on whether a user device is recognized. For instance, the system can be configured to display a login page to recognized devices and limit presentation of login function to only recognized devices. In order to use a device, users can add a new device to their account from a known device, for example, through request and approval operations similar to registration and verification. In other embodiments, an administrative user can add or associate new devices to user accounts.

In some embodiments, the system 100, engine 104 can be configured to capture registration information. In other embodiments, the system 100 and/or engine 104 can include a registration component 112 configured to request registration information. In one example, the registration component 112 can specify data fields that are presented within user interfaces to the user wishing to register. In some embodiments, the system 100 and/or engine 104 can include a user interface (“UI”) component 110 configured to generate user interfaces for display to the end users. The user interfaces presented to end users can be tailored to the devices being used to access the system.

According to one aspect, user registration can be managed (e.g., by the registration component 112) such that only users invited to use the system can register. For example, an existing user (e.g., physician) must add another user or request the other user be invited to access the system. According to one embodiment, the registration component 112 can be configured to manage registration of practice groups, provider groups, etc. For example, an administrative user can initially set-up registration for a group of providers and/or physicians. The administrative user can bulk create accounts for all physicians/providers within their group. The registration component 112 can also manage creation of respective patient accounts, for example, using the website. The registration component 112 can generate invitations for the respective patients and the system can communicate the invitations to them.

According to one embodiment, the system 100 and/or engine 104 includes a communication component 114 configured to communicate messages to unregistered users. For example, the communication component can be configured to deliver invitations to patients of respective physicians or providers. Further, the communication component 114 can be configured to manage delivery of invitations to providers and/or physicians associated with a practice group as well.

According to some embodiments, the communication component 114 can also be configured to manage secured communication between registered users. For example, a communication request (e.g., 102B) can be received and processed by the communication component to deliver a secure message (e.g., 106B) to another registered user. In some examples, the communication component 114 is configured to generate paired messages in response to a communication request. In one embodiment, the communication component 114 is configured to generate and deliver a push notification to a mobile device responsive to processing a secure communication to that user. For example, when a secure message is received (e.g., 102B) by the system, the secure message is routed for access by the user, but rather than deliver the message directly the user receives a notification that a message has been received for the user. In another example, a provider receives a push notification on their mobile device, for example, reading “you have a High Priority message” or “you have a Normal Priority message.” In some embodiments, the notifications are generated by the communication component 114 to ensure no sensitive patient information and/or medical information can be seen on the mobile device as the message is received.

According to one embodiment, the user then can tap the push notification message banner which causes their device to execute their secure provider application. The user can then log in to access/read their new message, which is stored on a message server. According to one embodiment, the local copies of the message are created for viewing only, and no information is retained, for example, on a local device once the application closes.

In further embodiments, the communication component 114 is configured to manage and/or control the communication functions made available to users. According to one embodiment, patient users are only permitted to message a physician or provider that has messaged them. For example, the system, engine, and/or communication component 114 can be configured to prevent communication from patients to other users. In response to explicit authorization, for example, by a physician the system, engine and/or communication component can permit patients to message their physician or provider. In further embodiments, the communication component can be configured to limit patient access to messaging functions associated with their providers within the database. In one example, the user interface component 110 can be configured to limit displays associated with messaging functions responsive to settings set by providers and/or physicians responsible for their care.

Once users are registered, the system 100, engine 104, and/or communication component 114 enables the registered users to securely communicate medical information to other registered users. In some embodiments, the system is configured to ensure compliance with federal and local regulations associated with communication and storage of medical information. For example, the communication component can be configured to monitor communication content transmitted between users against regulatory rules. In one example, the system can include a regulatory component 116 configured to define content rules and requirements. The content rules and requirements can define operations that maintain compliance with HIPAA regulations. Further, the regulatory component can include jurisdictional specific rules. For example, state based regulation(s) can be implemented as jurisdictional specific rules. The regulatory component 116 can be configured with rules for each and any jurisdiction in which a registered user is located or from which the user initiates or receives a communication. In the United States, for example, each state can be associated with jurisdictional rules. The communication component can be configured to ensure compliance with each jurisdiction. In one example, the communication component 114 analyzes communicated medical information to ensure the message content complies with all appropriate rules.

According to one embodiment, the communication component 114 can access rules and/or requirements managed by the regulatory component 116. The communication can component 114 can be configured to determine what rules to execute on communications in-transit, for example, responsive to a determined originating user location and a destination user location. In some embodiments, message content can be modified in-transit based on execution of rules managed by the regulatory component 116.

According to another aspect, medical information is also subject to regulation regarding storage, backup, and/or archiving. According to some embodiments, the system and/or engine can include a storage component 118 configured to manage secure storage of medical information. In one example, a series of main communication servers can be configured to provide real time back up and storage of all data communicated on the network provided by the system and applications. According to some embodiments, all the data received by a client will be encrypted on the server on which it is intended to be stored. In further embodiments, the storage operations executed by the storage component 118 can be executed responsive to regulatory rules and/or requirements stored in the regulatory component 116. In some examples, the regulatory component 116 include regulatory rules configured to manage various privacy laws, for example, state specific privacy laws where data will only be stored in within a state/region from which it originates.

According to some embodiments, the storage component 118 is configured to generate secure backups of medical data and any communication. In some examples, the data is secured and encrypted. According to further embodiments, the system is configured to manage communication of medical data by encrypting all transmission of the data. Encrypted medical data can be communication from one communication server to another. The system can be configured to communicate data encrypted to another machine for backup. According to some embodiments, the system can be configured to distribute backups between machines in the system's network. In other embodiments, the storage component is configured to analyze regulatory rules managed by the regulatory component to determine if privacy laws allow the backup data to be sent to a remote machine, for example, in another state.

In some implementations, security features implemented by the system control what content and/or functions can be accessed on the system, even by registered users. In some embodiments, device identification is employed to filter access to functions provided by the system. For example, if the system determines a device is registered it will show the login page and allow access to functionality provided by the system. If the system determines a device is not registered, the system can be configured to disallow login (e.g., the system can be configured to not show the login or not accept entry of login credentials). In other embodiments, a user can login to the system with an unregistered device, however, functions within the system can be disabled, prevented, and/or be un-selectable in any interfaces displayed. In one example, the system can provide functions to enable the user to request registration of the un-recognized device, and prevent other functions on the system (e.g., communicate, review messages, etc). In some embodiments, after a user is initially approved to be a member (e.g., either by a system admin or through an account created by a provider admin) the system generates and communicates a URL to visit to register their device.

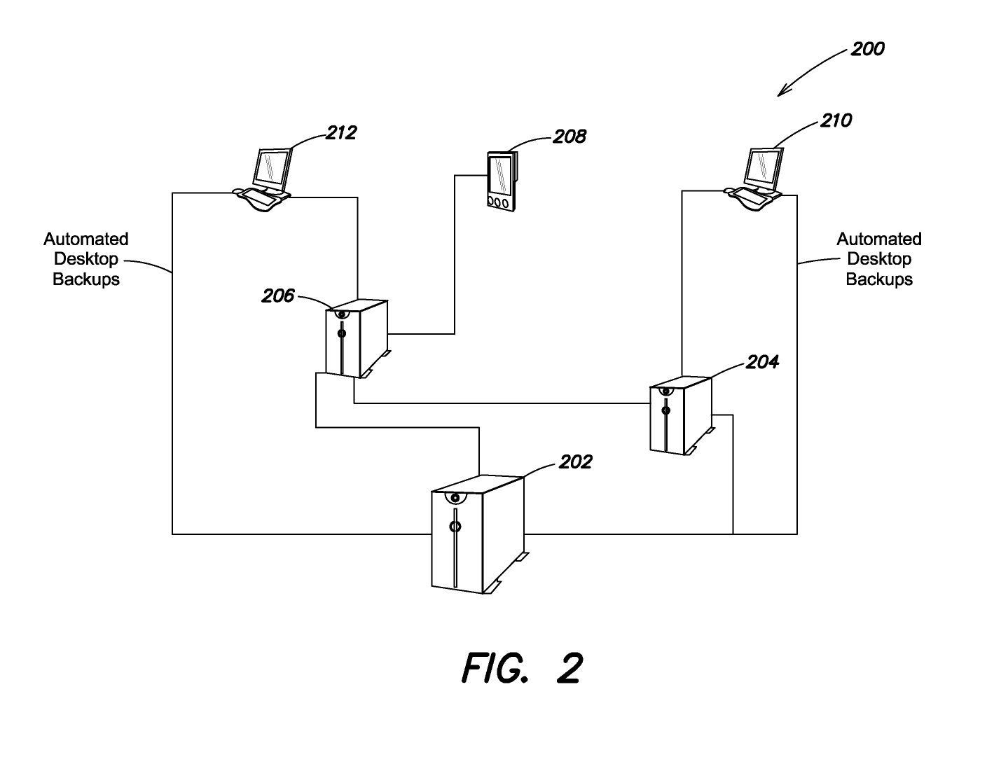

FIG. 2 is a block diagram of an example secure messaging environment 200. The secure messaging environment 200 includes secure messaging systems (e.g., 100) and can be configured to manage secure communications across a plurality of geographical locations, including for example, a plurality of states. The example secure messaging environment 200 illustrates two geographical jurisdictions (e.g., Massachusetts and Rhode Island). In other embodiments, the system spans additional jurisdictions, and in yet others, spans the states and territories for the United States.

In some embodiments, the system can be distributed across a plurality of communication servers (e.g., 202, 204, and 206). As discussed, various ones of the plurality of communication servers can be geographically located to manage specific jurisdictions. In some embodiments, the secure communications are routed from a first user device (e.g., 208) to a first communication server (e.g., 206) to a second communication server (e.g., 204) to a second user and a second user's communication device (e.g., 210). Respective applications on respective user devices mediate the communication of medical information. According to some embodiments, the first and second communication servers (e.g., 204 and 206) can be configured to examine the content of the messages being communicated between the users to enforce compliance with regulatory rules (e.g., HIPAA specifications, local rules, etc).

According to some embodiments, the communication servers within the network are configured to refuse connections from unregistered device (e.g., including other communication servers). In some examples, all communication servers in the network are registered with each other and a connection will be refused if request does not come from a registered server. Further, the system can be configured to require that any device attempting to communication or receive information be registered. The communication server(s) can be configured to ensure that any communicating device is registered before both acceptance of the data request as well as at delivery of the requested data.

In some embodiments, a master communication server (e.g., 202) can manage local communication servers (e.g., 204 and 206). The master communication server can manage inter-server communication, communication settings, and/or reconfiguration of communication architecture. In further embodiments, the master server can provide administration functions associated with the system. The administration function can include definition of communication policies, regulatory rules controlling content delivery and/or distribution, among other options. In some embodiments, the maser communication server can also provide for back up functionality. As discussed, the master 202 can enforce regulatory rules associated with data backups and archiving. In further embodiments (not shown), a secure messaging environment can include multiple master servers and any number of communication servers connected to the master servers.

Example Communication

According to one embodiment, a user will open app on mobile device (e.g., 208) or open website on desktop (e.g., 210) and then log in with user name and password to the application on their respective device. In one example, the application is configured to display an initial warning message upon log in on mobile device (e.g., as a pop up display) recommending the user connect on a known and/or secure Wi-Fi network. For users with, for example, iPhone devices, the system captures the user's device token which can be used to send push messages to the user. The system can also be configured to incorporate the device token in data encryption functions.

The system displays messaging functions that allow administrative users to create and send access invitations to providers within the verified contact list (e.g., a verified practice group). In some embodiments, individual users (e.g., solo physicians) cannot add their own contacts, however, in further embodiments the individual user can trigger an invitation sent by the system. The invitee can join the registered community after completing the verification process (e.g., by verifying NPI, work address/phone, etc).

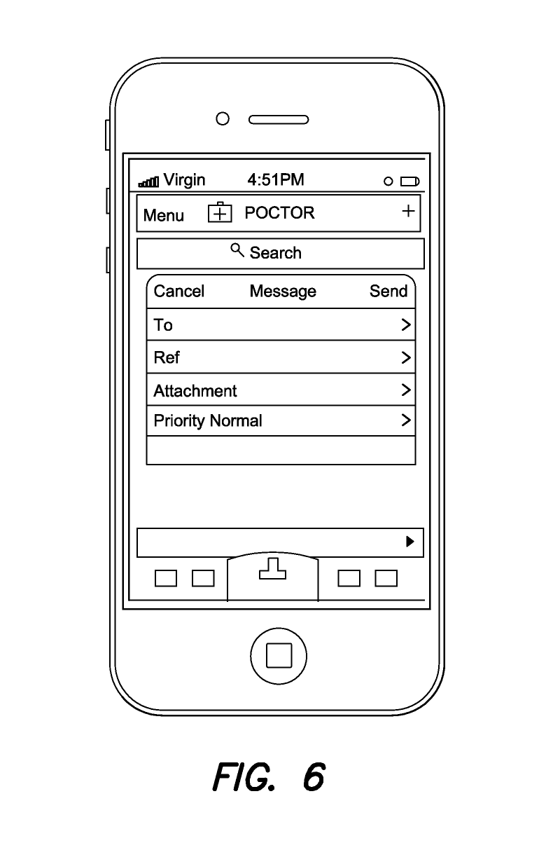

In order to send a message, the user can select a provider or group of providers from their contact list (each provider within the contact list has likewise been verified). The message interface is configured to provide commonly use messaging fields. For example, delivery targets are specified by a “To” section. A subject of reference can be required by the system in order to communicate. For example, the user must input or assign a reference (e.g., a free text field) in a “Ref” section, and then if desired insert multi-media content (e.g., images) in an “Attachment” section. In further embodiments, the message can include a selectable priority (e.g., “High” or “Normal”), in a “Priority” section prior to sending the message. Shown in FIG. 6 is a screen capture of an example user interface displayed by the system to the user.

According to one embodiment, the recipient receives a push notification generated by the system from the message input by the sender. For example, the recipient's device with display a push notification reading “you have a High Priority message” or “you have a Normal Priority message.” The system is configured to generate the notifications such that no sensitive patient information can be seen on the mobile device as the message is received. The notification and notification display is configured to enable the user to select the notification message to execute the secure messaging application. The application will prompt the user for log credential and transition directly to the new message. The new message is accessed by the application from a message server, rather than being distributed to the device directly. According to one embodiment, the local copies of the message are created for viewing only, and no information is retained, for example, on a local device once the application closes.

The system can provide functionality within the received message to enable the user to Reply or Forward the message. Responsive to selection of reply or forward, the user is presented with their communication list of verified/registered users. Through secure messages information can be shared between providers or groups about their patients creating an information/message “stream.” The information stream can be maintained in chronological order with an original message fixed at the top of the page (e.g., stream display) and most recent messages just below this working from top to bottom. In some examples, the date and time embedded within each message can be displayed as part of the message stream. In some embodiments, the system is configured to “auto archive” message streams after 24 hrs, for example, by a communication server.

In some embodiments, sensitive patient information is not stored on the individual device itself. For example, the message data including for example, any sensitive medical information can be stored and accessed on the communication servers through the secure application. The messages and/or content are accessible, for example, through search functions executed by the application. In one example, free text entered in each message can be searched and used to access matching messages (e.g., free text entered into the “Ref” (reference) section of a message can be searched).

In some embodiments, users can control backup and/or archiving functions executed by the system. For examples, users can access an “archive” or “don't archive” option is administration user interfaces provided by the application. Selecting archive can be configured to trigger the system to archive message immediately instead of waiting 24 hrs or keep the message stream (temporary view) on their device longer. If they choose Don't Archive then the message will always show on the iPhone as available.

According to some embodiments, the system (e.g., 100) and/or the secure application can provide additional functionality associated with contacting registered users. For examples, the application can provide a “quick contact” option where the user can tap on an individual's avatar/image, which caused the application to transition to the selected user's profile. According to some embodiments, the user interfaces include a “call now” display configured to trigger a phone call on a mobile device to reach the user immediately. In some examples, within any user profile display a “call now” feature will be displayed as well as a “message” display. The message display can be configured to transition the application to messaging functions and displays.

In further embodiments, each user can establish contact rules and/or call acceptance rules. For example, a user can defined “on duty” and “off duty” contact rules, where off duty statuses are displayed by the system to other users trying to contact the off duty user.

As shown by way of example in FIG. 2, the system can be implemented in a variety of environments including within a geographically located secure data storage network and retrieval systems. The system can include geographically located servers in a particular located within specific state/region to handle all data push and/or pull requests from users within that state/region. In some embodiments, the system can include one or more core directory servers configured to manage routing of push and/or pull requests to the correct geographically located server. In further embodiments, the system can include master servers that provide real time back up storage of all data on the network. For example, all the data received by a client will be encrypted on the server on which it is intended to be stored. Due to various privacy laws some of which are state specific, data storage and/or backup can be limited to a specific state/region. In further embodiments, transmission of data from server to server is configured to employ SSH (Secure Shell) connections encapsulated within a VPN tunnel, with all data being encrypted.

According to one example, data between a mobile phone, and/or desktop is communicated to the server in the state/region of the originating user using SSL encryption, VPN Tunnel to the server in the destination region, and then to the destination user device. Various encryption methodologies can be employed by the system, including, for example, secure symmetrical encryption methodologies such as DES and AES encryption which can be combined with other methodologies to make it more difficult to decrypt. In some embodiments, the data on any of the servers is encrypted using the same or similar encryption/decryption standard. For example, the standard can include combinations of known algorithms of symmetrical encryption methods, which can be enhanced by additional methodologies.

If data is needed in one state from a server in another state, that data will be transmitted securely between servers as outlined above. This might be necessary to provide a physician seeing a patient in more than one state with the information they need. In another example, inter-state transmission can also be necessary if that patient needs to see different physicians in different states. According to one embodiment, the system can manage the communication of the data and enforce any regulatory restriction at an originating location and a destination location.

The can also be configured to secure backups of any data. For example, backup data is encrypted and the encrypted data from one machine can be sent encrypted to another machine for backup. The system can be configured to generate backups automatically and, for example, between machines in the secure messaging network. If privacy laws allow the backup data will be sent to a remote machine possibly in another state.

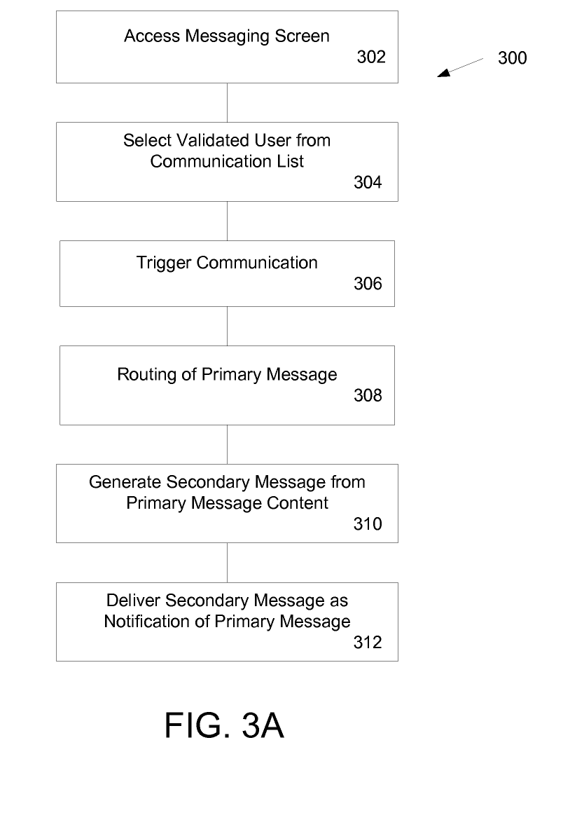

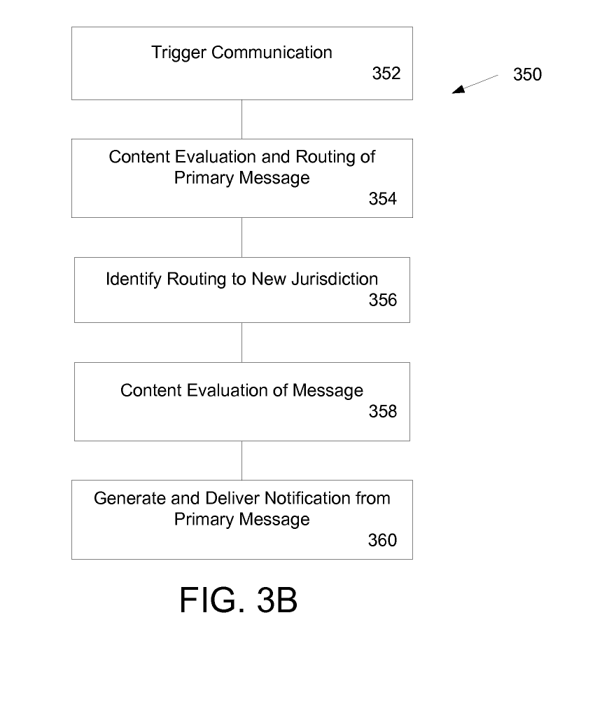

According to some embodiments, a secure messaging system(s) can execute a variety of processes to manage, deliver, and/or generate secure messages. FIG. 3A-B shows example processes 300 and 350 for secure messaging, which can be implemented, for example, by the secure system (e.g., 100, 202, and/or engine 104 of FIG. 1). According to one embodiment, process 300 begins at 302 with access to messaging functions. In one example, a user can trigger an application on their respective device and navigation through the application to access a messaging screen. At 304, a recipient for a communication is selected. In some embodiments, the messaging screen will display validated users to select for communication. The messaging lists can be restricted to validate users, patients, practice group, etc. Once the recipient is selected, message content (e.g., text, media, images, etc.) can be input or generated. At 306, the communication of the message is triggered. For example, the user can select send in the messaging screen. At 308, the message is routed for delivery to the recipient. According to some embodiments, a communication server receives the message, identifies the recipient, a location for the recipient, and routes the communication for delivery to the recipient. Routing can include identifying a geographically proximate communication server to the recipient. Alternatively, a communication server can be identified that includes jurisdictional rules associated with the recipient's location. The message can be route to that server and the content validate against jurisdictional rules (discussed in greater detail below with respect to FIG. 3B).

According to some embodiments, process 300 can continue at 310 with the generation of a secondary message from the content of the primary. For example, a priority can be captured from the primary message and included in the secondary message or used to assign a priority value to the secondary message. When the secondary massage is generated, no health information is included as the secondary message is design to be delivered as a push notification to, for example, and iPhone. At 312, the secondary message can be delivered as push notification to other devices (e.g., tablets, android devices, other smart phones, etc.). Regardless of the type of device being communicated to, the secondary message is generated to only include generic information (e.g., “you have a message of ______ priority”). For desktop applications, the application can be configured to trigger wall notifications on the desktop system. In other examples, the notification can be delivered as a text, e-mail, among other options.

Various other processes and/or sub-processes can be executed during communication of secure messages. Shown in FIG. 3B is an example process 350 for secure messaging. The process 350 begins at 352 with a triggered communication from a first user to a second user. At 354 messaging content from the communicating user (e.g., first user) can be evaluated to ensure compliance with health information regulations (e.g., HIPAA, local rules, state regulations, etc.), for example, as part of routing of the message. Upon identification of routing to a new jurisdiction at 356 further content evaluation of the message can be executed at 358 to ensure compliance with any requirements of the new jurisdictions. In some alternatives, the content evaluation can occurs in less steps where sending and receiving compliance can be executed together (e.g., as one step). In other example, various geo-located systems are positioned within respective jurisdictions, and the geo-located systems executed content evaluations base on the locations is which they are located. Once content compliance is complete, a notification can be generated and delivered to the recipient regarding the primary message (e.g., at 360).

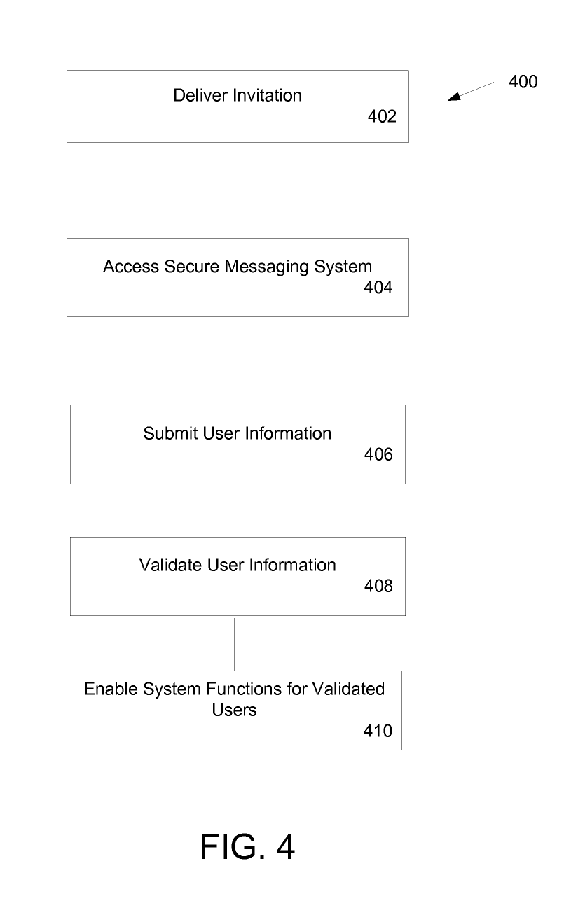

According to some embodiments, communication in the secure messaging is managed between registered and validated users. FIG. 4 shows an example process 400 for registering users to communicate on the secure messaging system. The process 400 beings at 402 with delivery of an invitation to participate in the secure messaging system. In some examples, the invitation at 402 is triggered in response to an existing user requesting a new user be added. In other examples, a request to participate can be processed by the secure messaging system. Upon validating the requesting user is a physician and/or medical professional, the system can generate and deliver an invitation at 402. In further examples, registered physicians can invite their patients to participate in the secure messaging system. In still further examples, once added the patients are not permitted to message the physicians, but rather the system default to physician to patient communication only. The physician can override such settings and allow patients to securely message by changing communication settings, for example, on a user/patient by user/patient basis.

At 404, the user can access a secure messaging system to begin registration, for example, using the information provided in the invitation. In some embodiments, the invitation can specify user roles for the invited users. For example, administrative user can subscribe groups of physicians (e.g., a practice group) to the secure messaging system. Thus, a user role can be a factor in the functions provided. For individual physicians, process 400 can continue at 406, with submission of their practice information, contact number, NPI, social, last four of their social, etc. The provided registration information can be used to validate the physician, for example, using the NPI number, and last four of the physician's social at 408. Only once the user is validated are system communication functions enabled for the user, for example, at 410.

In further embodiments, once an administrative user is registered, the administrative user can trigger, for example, process 400 by sending invitations to a practice group. In other embodiments, administrative user and physician users can both invite patients associated with providers/physician to access the secure messaging system.

According to some embodiments, the system can be implemented on a variety of computer systems and/or a variety of system architectures. Shown in FIG. 5 is a block diagram of a distributed computer system 500, on which various aspects and functions disclosed herein can be practiced.

As shown, the distributed computer system 500 includes one more computer systems that exchange information. More specifically, the distributed computer system 500 includes computer systems 502, 504 and 506. As shown, the computer systems 502, 504 and 506 are interconnected by, and may exchange data through, a communication network 508. The network 508 may include any communication network through which computer systems may exchange data. To exchange data using the network 508, the computer systems 502, 504 and 506 and the network 508 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 502, 504 and 506 may transmit data via the network 508 using a variety of security measures including, for example, TLS, SSL or VPN. While the distributed computer system 500 illustrates three networked computer systems, the distributed computer system 500 is not so limited and may include any number of computer systems and computing devices, networked using any medium and communication protocol.

As illustrated in FIG. 5, the computer system 502 includes a processor 510, a memory 512, an interconnection element 514, an interface 516 and data storage 518. To implement at least some of the aspects, functions and processes disclosed herein, the processor 510 performs a series of instructions that result in manipulated data. The processor 510 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 510 is connected to other system components, including one or more memory devices 512, by the interconnection element 514.

The memory 512 stores programs and data during operation of the computer system 502. Thus, the memory 512 may be a relatively high performance, volatile, random access memory such as a dynamic random access memory (DRAM) or static memory (SRAM). However, the memory 512 may include any device for storing data, such as a disk drive or other non-volatile storage device. Various examples may organize the memory 512 into particularized and, in some cases, unique structures to perform the functions disclosed herein. These data structures may be sized and organized to store values for particular data and types of data.

Components of the computer system 502 are coupled by an interconnection element such as the interconnection element 514. The interconnection element 514 may include one or more physical interconnection elements, for example, interconnection elements between components that are integrated within a same machine, but may include any communication coupling between system elements including specialized or standard computing interconnection element technologies such as IDE, SCSI, PCI and InfiniB and. The interconnection element 514 enables communications, such as data and instructions, to be exchanged between system components of the computer system 502.

The computer system 502 also includes one or more interface devices 516 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 502 to exchange information and to communicate with external entities, such as users and other systems.

The data storage 518 includes a computer readable and writeable nonvolatile, or non-transitory, data storage medium in which instructions are stored that define a program or other object that is executed by the processor 510. The data storage 518 also may include information that is recorded, on or in, the medium, and that is processed by the processor 510 during execution of the program. More specifically, the information may be stored in one or more data structures specifically configured to conserve storage space or increase data exchange performance. The instructions may be persistently stored as encoded signals, and the instructions may cause the processor 510 to perform any of the functions described herein. The medium may, for example, be optical disk, magnetic disk or flash memory, among others. In operation, the processor 510 or some other controller causes data to be read from the nonvolatile recording medium into another memory, such as the memory 512, that allows for faster access to the information by the processor 510 than does the storage medium included in the data storage 518. The memory may be located in the data storage 518 or in the memory 512, however, the processor 510 manipulates the data within the memory, and then copies the data to the storage medium associated with the data storage 518 after processing is completed. The processor 510 can also manipulate the data and provide manipulated data to a user on a display and/or a communication interface. A variety of components may manage data movement between the storage medium and other memory elements and examples are not limited to particular data management components. Further, examples are not limited to a particular memory system or data storage system.

Although the computer system 502 is shown by way of example as one type of computer system upon which various aspects and functions may be practiced, aspects and functions are not limited to being implemented on the computer system 502 as shown in FIG. 5. Various aspects and functions may be practiced on one or more computers having a different architectures or components than that shown in FIG. 5. For instance, the computer system 502 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems. As another example, the computer system 502 can be a mobile computing device, such as a smart phone or a tablet computer.

The computer system 502 may be a computer system including an operating system that manages at least a portion of the hardware elements included in the computer system 502. In some examples, a processor or controller, such as the processor 510, executes an operating system. Examples of a particular operating system that may be executed include a Windows-based operating system, such as, Windows NT, Windows 2000 (Windows ME), Windows XP, Windows Vista, Windows 7, 8, or RT, operating systems, available from the Microsoft Corporation, a MAC OS System (e.g., X) operating system available from Apple Computer, one of many Linux-based operating system distributions, for example, the Enterprise Linux operating system available from Red Hat Inc., a Solaris operating system available from Sun Microsystems, a UNIX operating system available from various sources, or a mobile operating system such as Apple iOS, Google Android, etc. Many other operating systems may be used, and examples are not limited to any particular operating system.

The processor 510 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as Python, PHP, .Net, SmallTalk, Java, C++, Ada, or C# (C-Sharp). Other object-oriented programming languages may also be used. Alternatively, functional, scripting, or logical programming languages may be used, in conjunction with traditional operating systems and/or mobile operating systems (e.g., Apple iOS, Google, Android, etc.).

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters, and thereby configure the behavior of the components.

### Example Functions and User Facing Settings

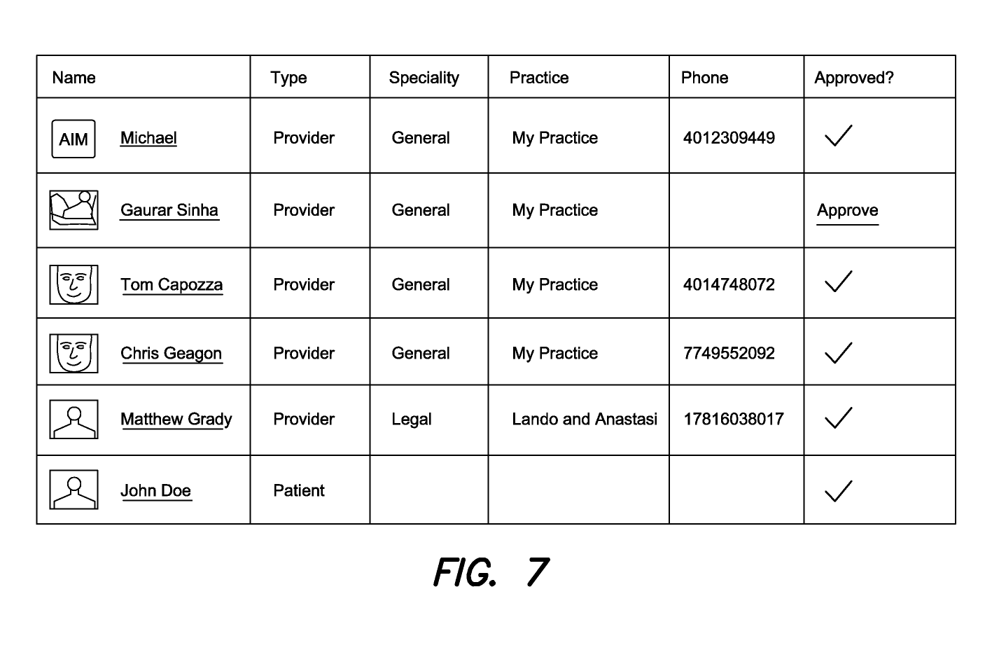

According to some embodiments, the application can display a number of user facing screens for configuring behavior and/or operation of the system. For example, the user can view an admin page by clicking on Admin in the navigation bar in the application. By default the administration page can be configured to display all the users associated with a user account (e.g., medical practice groups or other validated physicians, etc.). For example shown in FIG. 7 is an example user interface for accessing an administrator page. An administrator display can be configured to display providers/physician within a practice group. As shown, the admin can approve a provider by clicking on Approve in the “approved?” column. Each provider can be associated with a user profile. In various user interfaces, clicking on the name or the avatar of the specific user transitions the system to the selected user's profile.

According to other embodiments, the administration page can include navigation displays for accessing provider information. For example, a navigation bar can include selections at least for providers, patients, contact message (e.g., view prior communication). Responsive to selecting providers, the system presents all available providers. In some examples, the user interface provides functions for a message all feature, configured to generate a secure message to all listed providers. In another example, a message all function can be provided with respect to patients. To view the messages sent by other users through the contact form, the user can click on Contact Messages.

According to another embodiment, admin users can customize approval e-mails delivered to approved providers. For example, the system can provide access to an approval e-mail file to edit welcome information. For example, the system can provide access to an approve_member.php file:

```
try{
    $mail->From = ‘info@poctor.com’;
    $mail->FromName = ‘Poctor’;
    $mail->addAddress(“$member_email”);
    $mail->addCC(“info@poctor.com”);
    $mail->WordWrap = 90;|
    $mail->Subject = “Poctor - Registration Approved”;
    $mail->Body = “Congratulations, Your registration at Poctor has
    been approved
    $mail->send( );
}catch(phpmailerException $e) {
    echo $e->errorMessage( );
} catch (Exception $e) {
    echo $e->getMessage( );
}
```

According to some embodiments, the system can assign user roles to user accounts. For example, a provider admin role can be configured to enable adding and/or approving other providers to use the secure messaging system. The system can provide user interfaces to manage creation, and authorizations for other providers/users. FIG. 8 shows a “new provider” page for creating a new provider to be invited to the secure messaging system. Once the admin user fills in all the details of the provider and hit submit, the system will track and report on the status of the created provider (e.g., successfully validated).

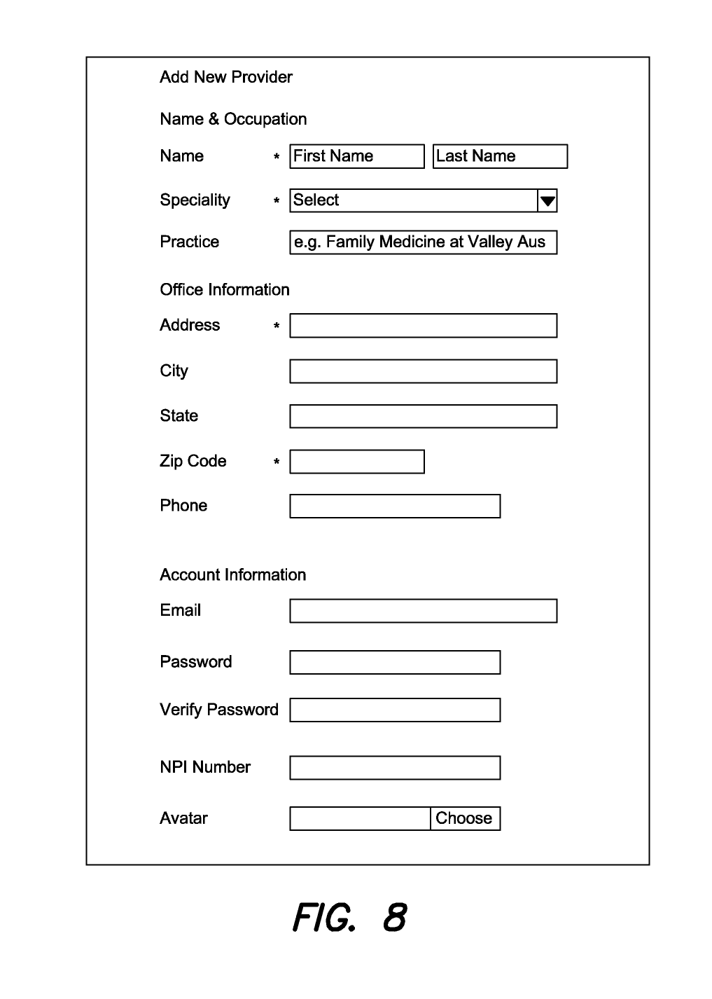

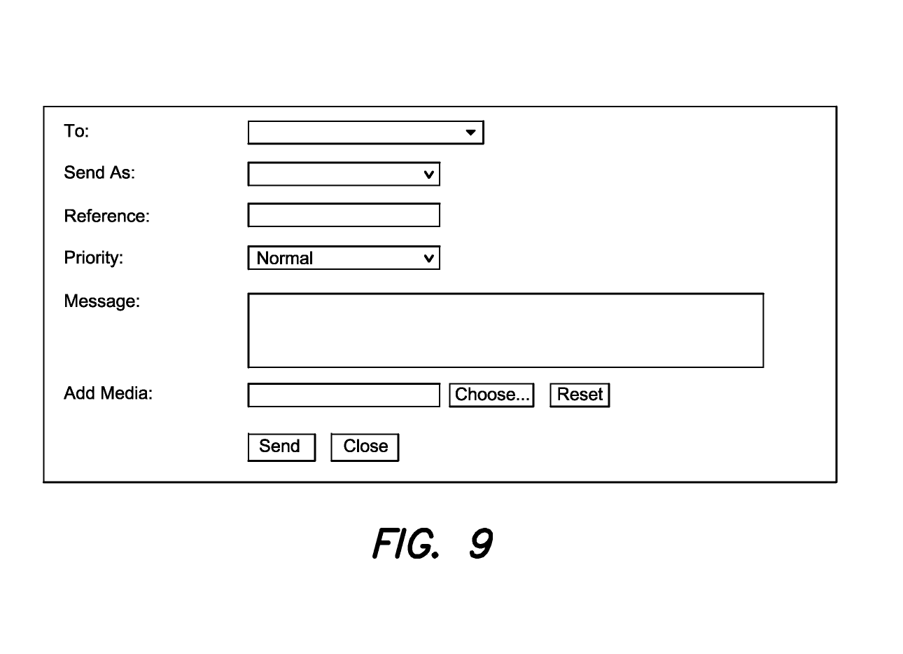

Admin functions can include, for example, management of group feeds. In example, the user can manage the feed of the providers in a group by selecting Group Feed in a navigation bar. The system transitions to a page that shows all the messages sent to all the providers in the group. FIG. 9 shows an example messages user interface. As admin user can reply to any message on behalf of a managed provider. The admin also forward the message on behalf of your provider. In another example, the admin user can send new message on behalf of any of the providers in the group. The system can provide a “New Message” feature configured to allow users to create a new message, fill in new message details, and to select the Provider you want to send the message on behalf of. Once done the admin communicates the message by selecting “Send.” FIG. 9 is an example screen capture of a messaging user interface.

According to another embodiment, each provider user on the system is associated with a user role that includes functions for creating and managing an answering service through the secure messaging system. For example, a provider user can access a “Provider Admin page” from a navigation bar in the application. Selection of “Manage Answering Service” enables the user to create an answering service user yet. FIG. 10 is an example screen capture of a display for creating an answering service.

According to yet another embodiment, the provider user role can also define functions for creating and/or managing respective patients. A provider user can access a “My Patients” page by clicking on My Patients in a navigation bar. The My Patients page lists all the patients that you the user has created. To message all patients at once, the user can select “Message All patients” is the user interface. Responsive to selection the system opens a dialog box to enter message details. Once complete the user selects “Send” to send the message.

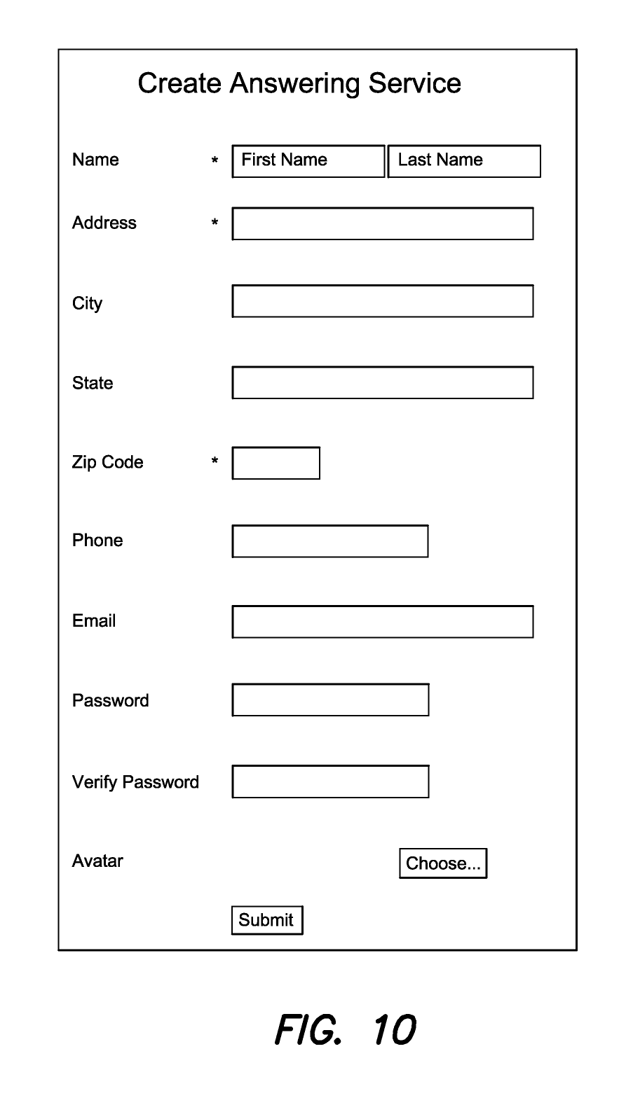

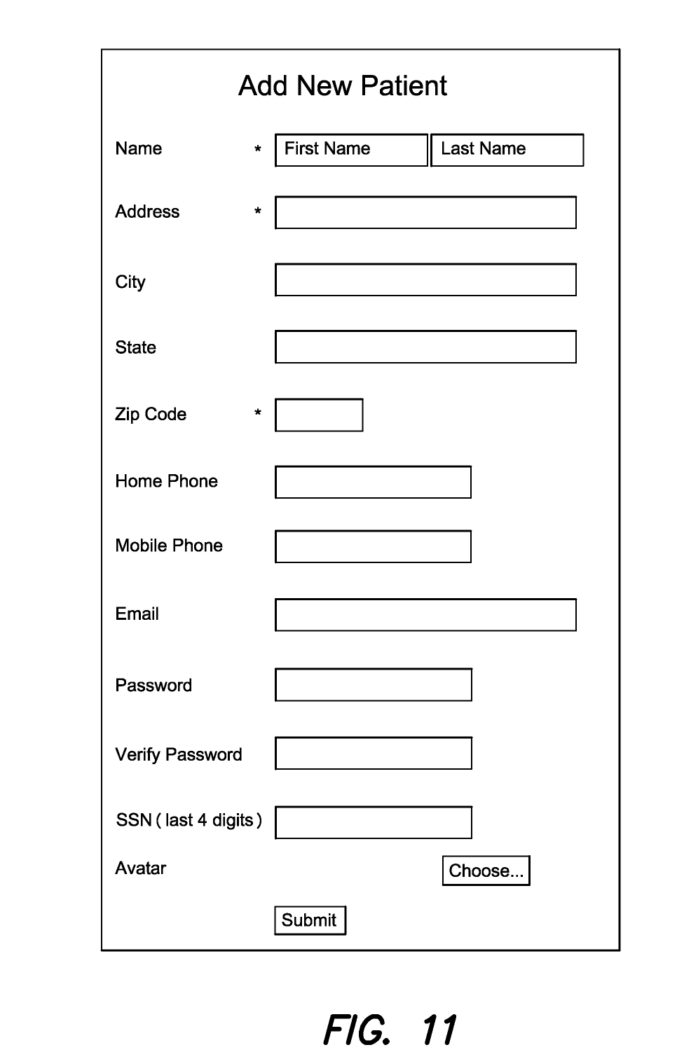

A provider user can also create a new patient. For example, the user can select “Add New Patient.” Responsive to selection the system transitions to an “Add New Patient” page (e.g., FIG. 11). The system tracks status associated with new patient accounts and provides notification messages if the patient gets successfully created.

Additional Example User Interfaces

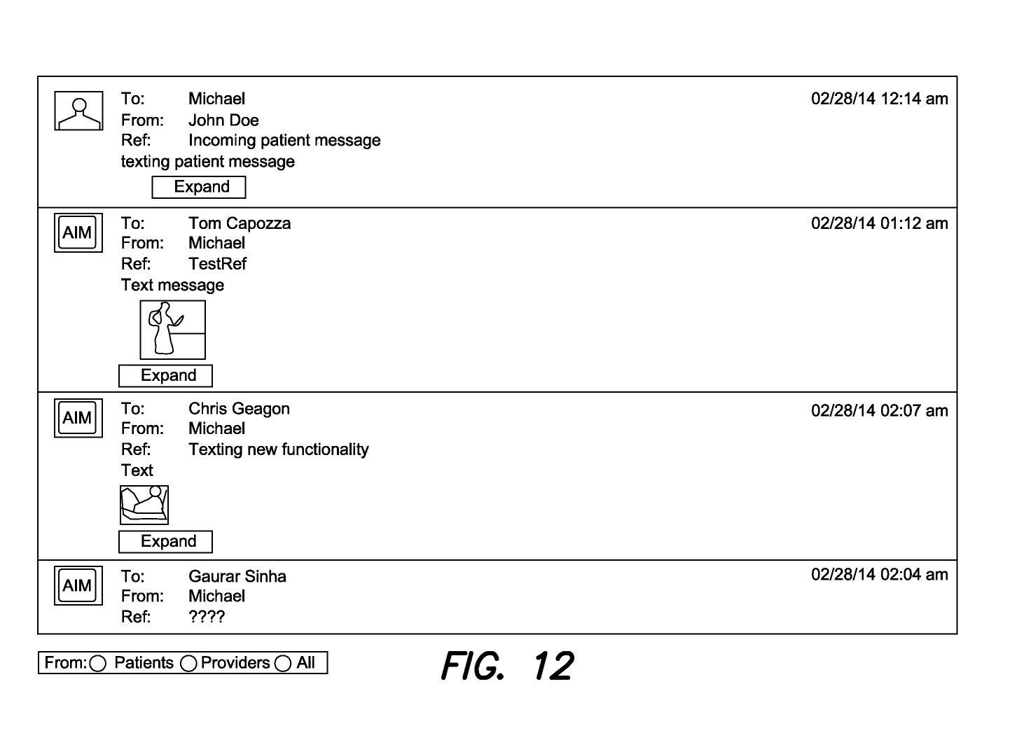

FIG. 12 is an example user interface for interaction with messages on the application. In one embodiment, users can access messages via a message page. Users can access the messages page by selecting messages in a navigation bar. The messages page is configured to display any messages the user has sent and/or received from user contacts. Messages can be filtered based on Patients and Providers via selection in the UI. In some examples, the UI includes a search box for searching messages based on matching input search criteria. The messages displayed can include expansion operations configured to allow the user to view and/or hide replies or messages within a message stream responsive to selection of the expansion operator.

According to one embodiment, if there are replies to a user communicated message, the user interface can include a “View Replies” function (e.g., display button). The function can include a visual indicator of the number of replies that are available. Users can also enter the message and click “Reply” in order to respond to any message. In other examples, users can also create a new message by clicking on “New Message” in the user interface (see e.g., FIG. 9). Users can also attach media to the message from a user operated device or from a user's media library.

Additional Functions

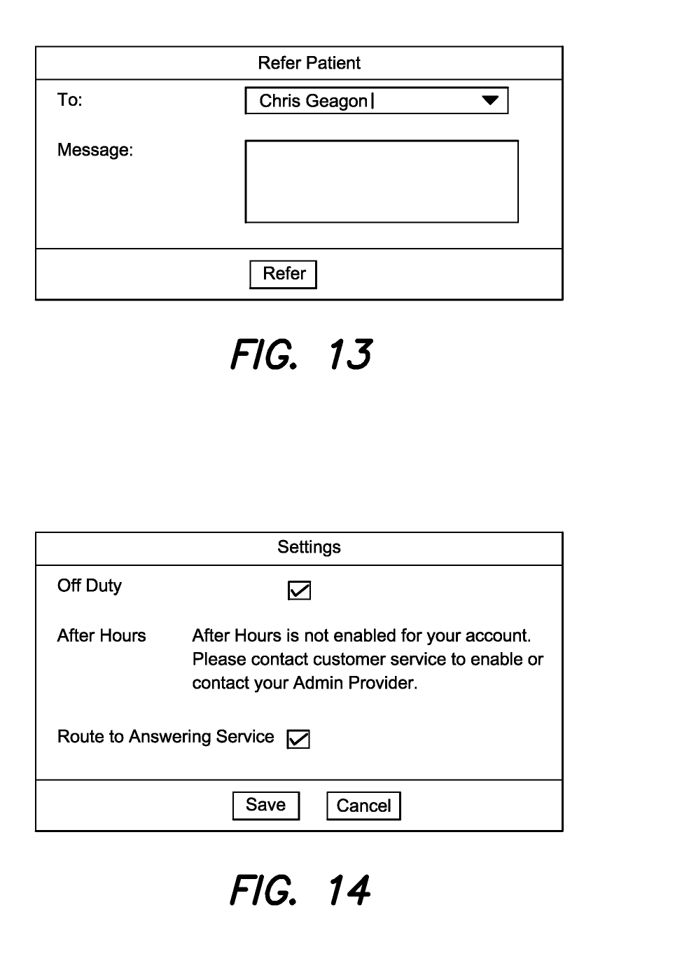

According to another embodiment, the system can be configured to accept and manage patient referrals between practitioners. For example, a user can refer their patient to another provider. In one embodiment, the user interface provides a ‘Refer’ function in the UI. In one example the refer function is display in the corresponding patient's row. Once selected the system is configured to require details on the referral through a dialog box. (See e.g., FIG. 13). Details can include the name of the provider to whom the user wanted to refer, with any desired message. In some embodiments, the system tracks the status of the referral and provides a message if the patient is successfully referred. Physician and/or admin users can control patient communication within the secure messaging system. For example, physician users can allow or disallow functions for a patient to message the physician. For example, the system can present a “My Patients” page, displaying all of the patients associated with the user. In one example, a column is presented in the UI “2 Way Communication,” configured to shows whether the patient is able to message the physician. In one embodiment, patient messaging to the physician is disabled by default. Users can toggle between allowed and disallowed for each patient responsive to selection in the UI.

According to some embodiments, the system, application, and/or UI can provide additional functions, including, for example, message export function (e.g., to .pdf), search functions by specialty, functions for managing availability status, among other options, including answering service functions (see e.g., FIG. 14). In further embodiments, export functionality can be further managed for regulatory compliance (e.g., requiring storage and/or creation in encrypted format if medical information is present).

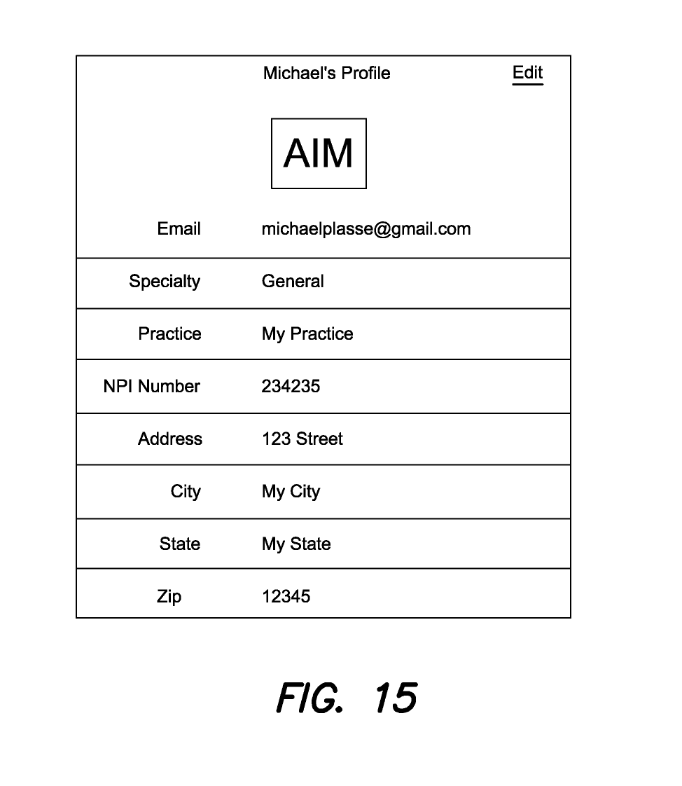

According to another embodiment, users can maintain respective media libraries associated with their account. Using the application, users can upload any media type and share or distribute the media content with other users. Additional functions can be accessed through other pages provided by the UI. For example, user profile information for respective users can be maintained and/or updated through a “profile page.” (See e.g., FIG. 15). Other functions can include support features, and users can contact system administrators/support suing a “Contact” page in the UI. Support requests can include password resets or other support functions. Yet other functions include after hours management and status displays for physicians. In addition to after hours functions, the system and/or application can provide automatic answering services. The answering service can be configured to respond automatically to received messages, provide pre-formatted auto-responses, etc. Further, an answering service user (which can include, for example, admin user, physicians within same practice group, etc.) can manage an answering service feed, accessed by selecting “Answering Service” tab in a navigation bar. The answering service page can be configured to display the feed from all the providers who have routed their conversations to the Answering Service. The answering service user can reply to any message on behalf of a provider and/or forward the message on behalf of a provider. To send a new message as one of the providers in the group, the answering service user can select “New Message,” fill in the messages details, and select one or more providers to send the message on behalf of, and then click send.

Example Database Implementations

According to various embodiments, the secure messaging system and/or the application can reference and/or store data according to various formats/schemas/hierarchy, or unstructured organization formats.

In one example, the data on users can include a members data object for storing at least some the system users' information. The members data object can include any one or more of the following data elements that are associated with respective users. An example members data object is defined by any one or more or any combination of the following data fields in Table I (e.g., Column A with use of data filed Column B).

TABLE I

| Data field (Column A) | Used for User (Column B) |
|---|---|
| phone | All except patients |
| name | All |
| email | All |
| password | All |
| device_token | — |
| Type | 1 for Providers |
| | 2 for Patients |
| | 3 for After Hours User/Answering Service User |
| avatar | All |
| specialty | Providers and Provider Admins |
| practice | Providers and Provider Admins |
| address | All |
| City | All |
| state | All |
| Zip | All |
| home_phone | Patients |
| mobile_phone | Patients |
| Npi | Providers and Provider Admins |
| approved | Providers who register through Sign Up |
| admin | Admin (value = 1), 0 for others |
| provider_admin | Provider Admins (value = 1), 0 for others |
| ah_enabled | Enabling After Hours setting for providers, NULL |
| | for |
| created_by | Patients |
| | Providers created by provider admins |
| | Answering Service created by Provider Admins |
| last_four_ssn | Patients |

According to another embodiment, messages are stored according to a format for a message data object. Tables II-IX describe examples of a variety of data object formats (e.g., messages format). In other examples, any one or more the data fields can be used, as well as additional data fields.

TABLE II
(Messages)

| Data Field (Column A) | Field Description (Column B) |
|---|---|
| Sid | Senders id in members table |
| Rid | Receivers id in members table |
| Reference | Reference text |
| Message | Actual message text |
| Date | Date and time of message |
| Type | Priority, 1 for High and 0 for Low |
| Image | File name of the image attached. |
| | Folder is webservices/app_images/ |

TABLE III
(Message_replies)

| Data Field (Column A) | Field Description (Column B) |
|---|---|
| Mid | Message id in messages table |
| Sid | Senders id in members table |
| Reference | Reference for the reply |
| Message | Reply text |
| Date | Date and time of reply |

TABLE IV
(Provider_settings)

| Data Field (Column A) | Field Description (Column B) |
|---|---|
| member_id | Provider's id in members table |
| off_duty | Setting off duty enabled (1) and disabled(0) |
| after_hours | Setting after hours enabled (1) and disabled(0) |

TABLE V
(Referrals)

| Data Field (Column A) | Field Description (Column B) |
|---|---|
| patient_id | Patient's id in members table |
| provider_id | Provider's id in members table to whom |
| | the patient was referred. |
| referred_by | Provider's id in members table who referred |
| | the patient. |
| referral_date_time | Date and time of referral |

TABLE VI
(2way_comm)

| Data Field (Column A) | Field Description (Column B) |
|---|---|
| provider_id | Providers id in members table who enables/ |
| | disables. |
| patient_id | Corresponding patient id in members table. |

TABLE VII
(Specialties)

| Data Field (Column A) | Field Description (Column B) |
|---|---|
| Id | Specialty Id |
| specialty_name | Name of the Specialty |

TABLE VIII
(Answering_service)

| Data Field (Column A) | Field Description (Column B) |
|---|---|
| provider_admin_id | Provider's Admin's Id in the members table |

TABLE IX
(Answering_service_status)

| Data Field (Column A) | Field Description (Column B) |
|---|---|
| provider_id | Provider's Id in members table |
| Status | 1 for enabled and 0 for disabled |

According to various embodiments, the system, engine, and/or application can include a variety of files executed to perform various functions, operations, or processes for managing secure messaging of medical information. Table X provides examples of file names, execution locations (e.g., front end and back end), and description of the use of the file during execution. According to one embodiment, the location of a front end file in the same row as a back end file denotes an operative relationship between the two files. In other embodiments, various ones or combinations of the files described in the Table X can be implemented for securely messaging medical information.

TABLE X

| front end file | Use | Back End Files | Use |
|---|---|---|---|
| header.php | Contains login form, | auth.php | Authentication and |
| | contact form and | | setting session |
| | other elements | | variables |
| | common for all pages | process_contact_form.php | Submission of |
| | | | contact |
| | | | form and emailing |
| head.php | Checks session at every page load. | | |
| forgot_password.php | For users who have | resend_password.php | Processes the |
| | forgotten password | | forgot |
| signup.php | For sign up for | process_signup.php | Processes the sign |
| | Providers | | up |
| | | signup_response.php | Successful signups |
| | | | are |
| functions.php | Used by various files, contains miscellaneous functions | | |
| menu.php | Used by all pages to display navigation menu | | |
| logout.php | Used to logout the user and unregister all session variables | | |
| index.php | Home page | | |
| db_config.php | Database settings | | |
| footer.php | Contains the footer | | |
| feed.php | Displays messages | send_new_message.php | For sending a new |
| | | | message |
| | | get_feed.php | Fetches the |
| | | | messages |
| | | update_messages_read.php | Updates the read |
| | | | status of messages |
| | | | and records the |
| | | | date of reading. |
| | | get_message_expansion.php | Fetches the reply |
| | | | box |
| | | | and replies for |
| | | send_message_reply.php | Processes the |
| | | | message |
| | | | replies sent from |
| | | get_message_replies.php | Fetches the |
| | | | messages |
| | | | replies after a reply |
| | | send_new_message.php | Processes the |
| | | | message |
| | | | sent from the New |
| | | forward_message.php | Processes the |
| | | | forwarded message |
| contacts.php | Displays Contacts | get_contacts.php | Fetches the |
| | and Top Contacts for | | contacts |
| | providers. Only Top | get_top_contacts.php | Fetches the top |
| | Contacts for | | contacts list |
| | | get_top_messages.php | Fetches the |
| | | | messages to be |
| | Specialties. | | clicking the |
| | | | message |
| provider.php | Displays providers | get_specialty_providers .php | Fetches providers |
| | under a specific | | from a specific |
| | specialty | | specialty |
| admin.php | Displays All | get_users.php | Fetches all |
| | members | get_contact_messages.php | Fetches messages |
| | | | sent |
| | | | through the contact |
| | | approve_member.php | Processes the |
| | | | approve |
| | | admin_browse_providers.php | Displays all |
| | | | providers |
| | | admin_get_providers.php | Fetches all |
| | | admin_browse_patients.php | Displays all |
| | | admin_get_patients.php | Fetches all patients |
| | | admin_browse_contact_messages.php | Displays all the |
| | | | messages sent |
| | | | through contact |
| | | admin_message_providers.php | To send messages |
| | | | to |
| | | admin_message_patients.php | To send messages |
| | | | to |
| manage_patients.php | For providers to | get_my_patients.php | Fetches patients |
| | manage patients | | for |
| | | get_patient_messages.php | Fetches the |
| | | | messages |
| | | | with patients on |
| | | export_patient_messages.php | For saving |
| | | | messages |
| | | refer_patient.php | Processes the |
| | | | referral request |
| | | update_2way_comm.php | Processes the |
| | | | request for |
| | | | enabling/disabling |
| | | send_new_message_patients.php | To send message |
| | | | to all |
| add_new_patient.php | Form for adding a | save_patient.php | Processes the |
| | new patient | | request |
| provider_admin.php | Displays all providers | get_providers.php | Fetches all |
| | under you | | provders |
| | | manage_answering_service.Php | Displays created |
| | | | answering service |
| | | | if it created. |
| | | | Otherwise displays |
| | | | a form to create an |
| | | | answering service. |
| | | save_answering_service.php | Processes the form |
| | | | for |
| | | | creating answering |
| | | send_new_message_providers.php | To send message to all |
| | | | providers collectively. |
| group_feed.php | Displays messages | get_group_feed.php | Fetches messages sent |
| | sent to all providers | | to all providers under |
| | under you | | you |
| | | send_provider_reply.php | Processes the reply |
| | | | sent by you on behalf |
| | | | of provider under you |
| | | forward_provider_message.php | Processes the forward |
| | | | request by you on |
| | | | behalf of provider |
| | | | under you |
| Media_library.php | Displays the media | Get_my_media.php | Fetches the media of |
| | you have uploaded | | the logged in user. |
| | and the media that | Upload_media.php | To upload and share |
| | has been shared with | | new media. |
| | you. | Get_media_share_users.php | Fetches users with |
| | | | whom media can be |
| | | | shared. |
| | | Save_media.php | Saves media in the DB. |
| | | Share_media.php | Associates media with |
| | | | users selected for |
| | | | sharing. |
| as_feed.php | Displays messages | get_as_feed.php | Fetches messages |
| | sent to all providers | | sent to all providers |
| | who have | | who have Answering |
| | Answering Service | | Service setting on |
| | setting on | | |
| profile.php | Displays your | save_provider_settings.php | Processes the update |
| | profile or others' | | of settings from |
| | profile | | profile page for |
| | | | providers |
| | | edit_profile.php | Displays form for |
| | | | editing your profile |
| | | update_profile .php | Processes the request |
| | | | for update of profile |
| after_hours.php | Displays messages | get_after_hours_feed.php | Fetches messages for |
| | sent to all | | all providers with |
| | providers who have | | After Hours setting on |
| | After Hours setting | | |
| | on | | |

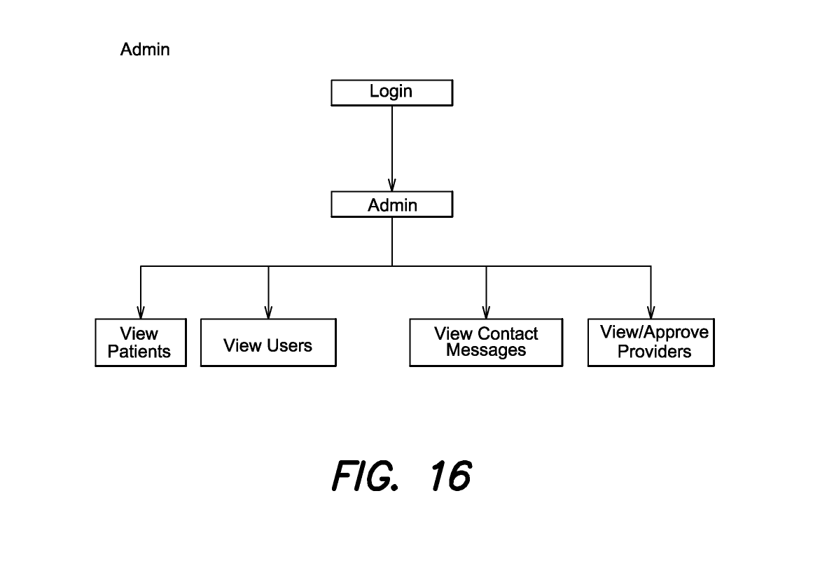

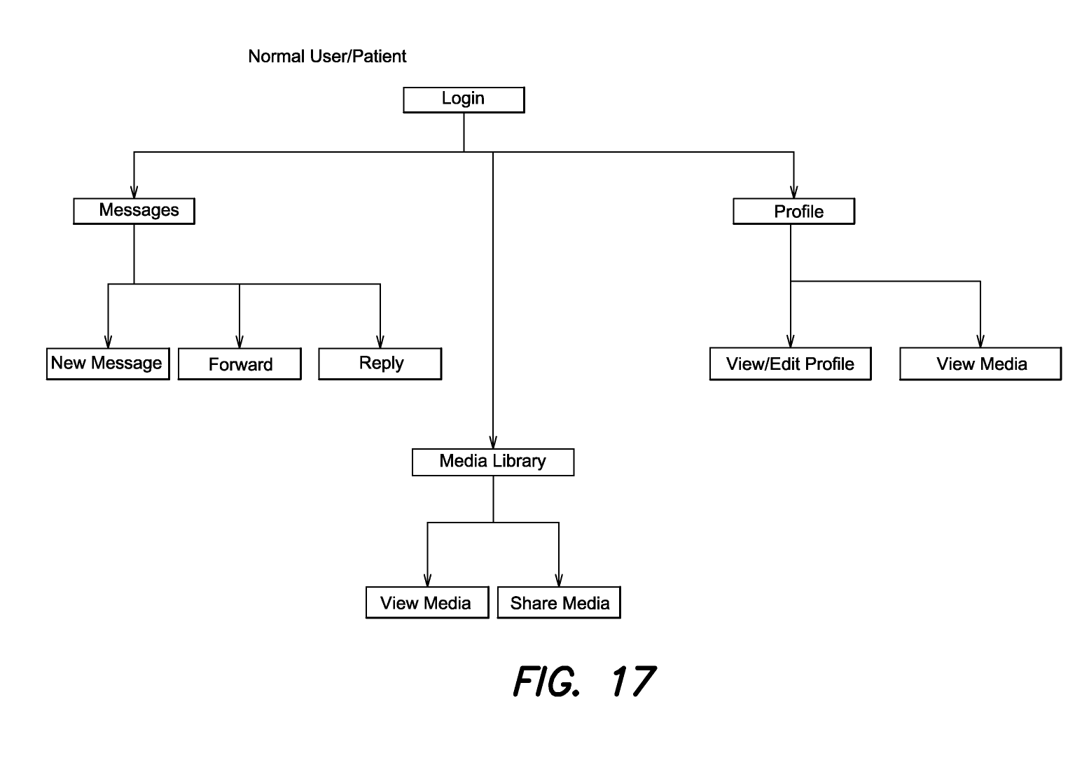

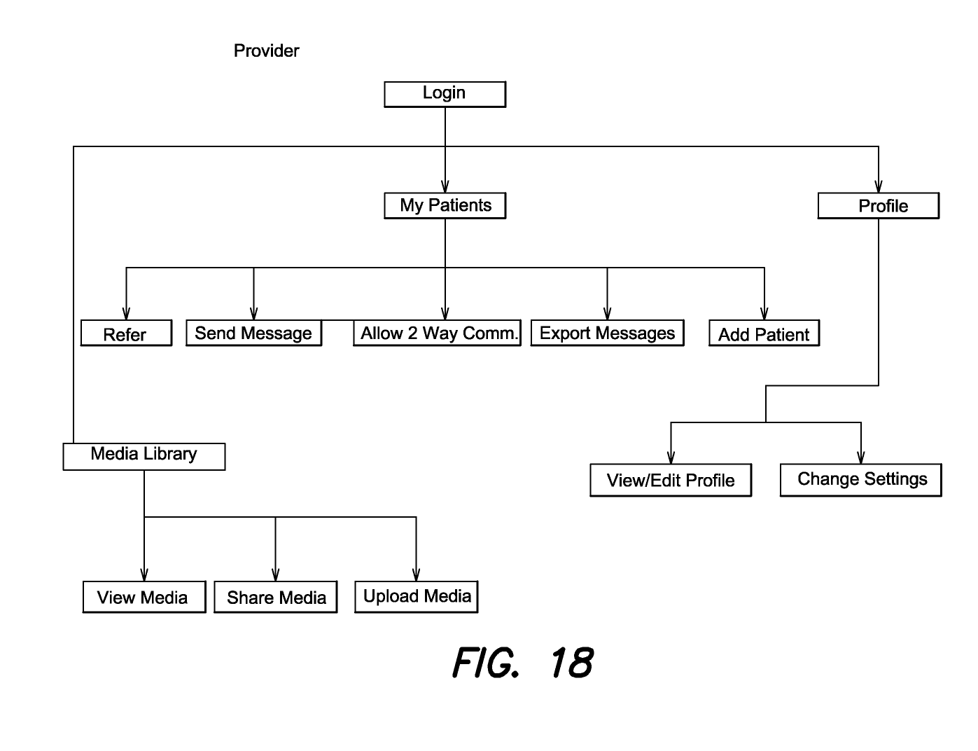

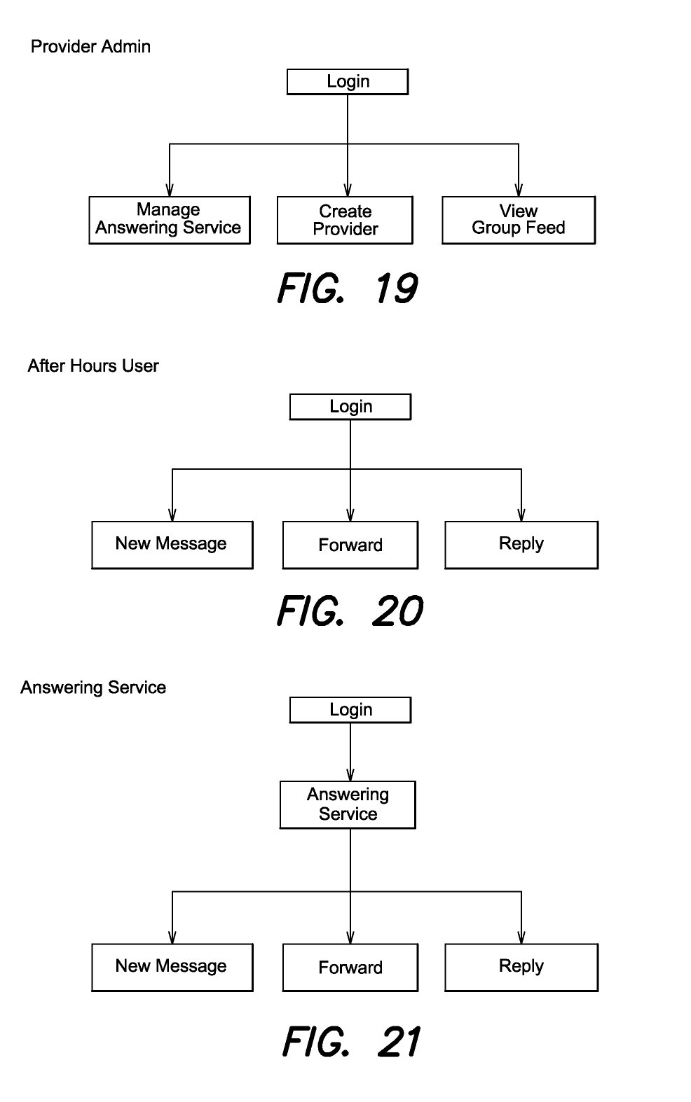

According to further embodiments, the system can include various user interfaces accessible through various navigation functions provided to users. According to various embodiments, the system can implement a number of various site maps, navigation flows between pages, site maps specific to users/user roles, etc. FIGS. 16-21 illustrate example site maps that can be implemented as part of a secure messaging system and/or secure messaging application. In other embodiments, various site maps and respective screen/function flows can be implemented including the mappings shown in FIG. 16-21, in some alternatives various ones of the pages and/or functions illustrated in FIGS. 16-21 can be implemented, as well as various combinations of the pages and/or functions illustrated. In other embodiments, different pages can be implemented to provide access to secure messaging functions and/or services.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention.

Accordingly, the foregoing description and drawings are by way of example only.

What is claimed:

1. A system for securely managing medical interactions, the system comprising
at least one processor operatively connected to a memory, the at least one processor configured to instantiate and run a plurality of system components when executing, wherein the plurality of system component comprise:
an authentication component configured to identify a plurality of users and respective user roles for the plurality of users;
a communication component configured to restrict communication functions between the plurality of users based on respective user role;
a role component configured to define user roles for the plurality of users including at least a patient role and a provider role, wherein users having the patient user role are prevented from accessing the system until invited, and prevented from communicating with the users of the system until explicitly authorized by a user having the provider role.

2. The system according to claim 1, wherein the role component is configured to define at least the patient role, the provider role, and a physician role that includes at least the functions of the provider role.

3. The system according to claim 1, further comprising an application generation component configured to tailor a mobile application to one or more provider users.

4. The system according to claim 5, wherein the application generation component publishes the mobile application for access through a secure website.

5. The system according to claim 1, further comprising a registration component configured to require entry of verification information for a user wishing to access the mobile application.

6. The system according to claim 5, further comprising a verification component configured to verify provider information submitted to the registration component.

7. The system according to claim 6, wherein the registration component requires submission of any one or more of: social security number, national provider identifier number, and work address plus phone number.

8. The system according to claim 5, wherein the registration component is configured to capture a device token or device identifier for each registered user.

9. The system according to claim 8, further comprising an encryption component configured to encrypt any communication between the users.

10. The system according to claim 8, wherein the encryption component generates encrypted data based, at least in part, on the captured device token or the device identifier.

11. The system according to claim 2, wherein the mobile application is configured to capture at least one media source from a user device on which the mobile application is installed and accept the at least one media source into a secure messaging channel provided by the mobile application.

12. The system according to claim 2, wherein the communication component is configured to execute a secure referral function, when executed enables users having the physician role to securely refer a patient and medical information to another physician.

13. The system according to claim 12, wherein the communication component is configured to automatically add a patient to the physician receiving the referral verified communication lists.

14. The system according to claim 1, further comprising an analysis component configured to analyze communicated content to ensure compliance with regulatory rules based at least in part on a sender's location and a receiver's locations.

15. A computer implemented method for securely managing medical interactions, the method comprising:
identifying, by a computer system, a plurality of users and respective user roles for the plurality of users;
restricting, by the computer system, communication functions between the plurality of users based on respective user role;
defining, by the computer system, user roles for the plurality of users including at least a patient role and a provider role; and
preventing, by the computer system, users having the patient user role from accessing the system until invited and from communicating with the other users of the system until explicitly authorized by a user having the provider role.

16. The method according to claim 15, further comprising defining at least the patient role, the provider role, and a physician role that includes at least the functions of the provider role.

17. The method according to claim 15, further comprising customizing a mobile application to one or more provider users.

18. The method according to claim 19, further comprising publishing the mobile application for access through a secure website.

19. The method according to claim 15, further comprising requiring entry of verification information for a user wishing to access the mobile application.

20. The method according to claim 19, further comprising verifying provider information submitted to the registration component.

21. The method according to claim 20, further comprising requiring submission of any one or more of: social security number, national provider identifier number, and work address plus phone number.

22. The method according to claim 19, further comprising capturing a device token or device identifier for each registered user.

23. The method according to claim 22, further comprising encrypting any communication between the users.

24. The method according to claim 22, further comprising generating encrypted data based, at least in part, on the captured device token or the device identifier.

25. The method according to claim 16, further comprising capturing at least one media source from a user device on which the mobile application is installed and accepting the at least one media source into a secure messaging channel provided by the mobile application.

26. The method according to claim 16, further comprising executing a secure referral function, when executed enables users having the physician role to securely refer a patient and medical information to another physician.

27. The method according to claim 26, further comprising adding, automatically, a patient to the physician receiving the referral verified communication list.

28. The method according to claim 15, further comprising analyzing communicated content to ensure compliance with regulatory rules based at least in part on a sender's location and a receiver's locations.

29. The system according to claim 1, further comprising:
a communication component configured to restrict communication functions between the plurality of users based on respective user role and message content; and
a regulatory component configured to evaluate communication content based at least in part on a sending user's location or a receiving user's location.

30. The system according to claim 29, wherein the communication component is further configured to generate a notification message to a recipient from content of an original message for the recipient responsive to communicate of the original message.

31. The system according to claim 30, wherein the communication component is further configured to generate the notification message by extracting non-regulated message content.
